(19) United States
(12) Patent Application Publication
(10) Pub. No.: US 2004/0216062 A1
(43) Pub. Date: Oct. 28, 2004

(54) Method of forecasting unit capacitance for chip design

(76) Inventor: Chen-Teng Fan, Hsinchu (TW)

Correspondence Address: RABIN & Berdo, PC, 1101 14TH STREET, NW, SUITE 500, WASHINGTON, DC, 20005, US

(21) Appl. No.: 10/422,856

(22) Filed: Apr. 25, 2003

(51) Int. Cl. G06F 17/50

(52) U.S. Cl. 716/5; 716/10; 716/13

(57) ABSTRACT

A method of forecasting a unit capacitance of a chip having a plurality of layers. Each layer includes a predetermined layout of metal lines. First, layout design parameters of the predetermined layout are obtained before forming the chip, such as number of layout layers, metal line width of each layout layer, distance between each metal line and the ratio of metal lines to routing channels. Next, a testing interconnection according to the layout design parameters is generated. Finally, the unit capacitance is obtained by a predetermined capacitance extraction tool according to the testing interconnection.

### BACKGROUND OF THE INVENTION

1. Field of the Invention

The present invention relates in general to techniques of extracting parameter measurements for circuit simulations. In particular, the present invention relates to a method of forecasting interconnected capacitances of a chip and using the forecasted interconnect capacitances to design the layout of the chip.

2. Description of the Related Art

As integrated circuits (IC) become increasingly laden with metal or polysilicon interconnects, the resulting interconnected capacitances are rapidly becoming a bottleneck in the design of faster ICs. It has therefore become very important to model these capacitances in order to accurately simulate the performance of ICs.

In the past, on-chip test structures have been used in attempts to model interconnect capacitances with higher accuracy and resolution. However, many of these test structures suffer from significant deficiencies which make them inefficient and/or result in their interconnect capacitance measurements being inaccurate and/or having low resolution.

A method for determining on-chip interconnect process parameters is disclosed by U.S. Pat. No. 6,312,963 in Nov. 6, 2001. The method fabricates some test structures including predetermined layouts to simulate the target layout. After testing the test structure, the interconnect process parameters of the target layout are modulated according to the testing result of the test structures. Here, the interconnect process parameters are the thickness of metal lines and interlayer dielectric thickness. The testing result comprises the information of the capacitance between the metal lines at the same layer or at another layer of the testing structure.

The conventional method is performed after the target chip fabricated to test the formation of the chip meeting the specification. If the testing result of the chip does not meet the specification, the interconnect process parameters of the chip are then adjusted according to the testing result. However, the test structures of the conventional method are simple, so the testing result is meaningless with the real condition of the chip. In addition, at this time, considerable time and cost are accrued to make the target layout, since at this point it is too late to discover the interconnect process failure when the target layout has been made up.

### SUMMARY OF THE INVENTION

The object of the present invention is thus to provide a method of forecasting the unit capacitance of a predetermined interconnection layout by simulating a testing structure according to the layout design parameters of the predetermined interconnection layout. The layout design parameters of the layout include number of layout layers, metal line width of each layout layer, distance between each metal line and the ratio of metal lines to routing channels, similar to the predetermined interconnection layout. After simulating the testing structure, the unit capacitance of the testing structure is obtained by resistance-capacitance (RC) extraction tools. Then, the unit capacitance is applied to the IC design processes comprising logic synthesis, floor plan, and clock tree synthesis. Thus, the capacitance of the fabricated chip approaches the forecasted capacitance, so the IC design convergence is improved.

To achieve the above-mentioned object, the present invention provides a method of forecasting a unit capacitance of a chip having a plurality of layers. Each layer includes a predetermined layout of metal lines. First, layout design parameters of the predetermined layout are obtained before forming the chip. The layout design parameters are number of layout layers, metal line width of each layout layer, distance between each metal line and the ratio of metal lines to routing channels. Next, a testing interconnection according to the parameters is generated. Finally, the unit capacitance is obtained by a predetermined capacitance extraction tool according to the testing interconnection.

In addition, the present invention provides a method for designing a chip having a predetermined layout. First, layout design parameters of the predetermined layout are obtained before forming the chip. The layout design parameters are number of layout layers, metal line width of each layout layer, distance between each metal line and the ratio of metal lines to routing channels. Next, a testing interconnection according to the layout design parameters is generated. Next, the unit capacitance is obtained by a predetermined capacitance extraction tool according to the testing interconnection. Floor_plan and clock_tree are performed according to the obtained unit capacitance. Finally, the chip is routed.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a flowchart of capacitance forecasting method according to the embodiment of the present invention.

FIG. 2A shows the MET1 layout of a chip.

FIG. 2B shows the MET2 layout of a chip.

FIG. 2C shows the MET3 layout of a chip.

FIG. 2D shows the MET4 layout of a chip.

FIG. 2E shows the layouts of MET1+MET2+MET3+MET4.

FIG. 3 shows the relationship between net count and the error ratio of the estimation capacitance before routing to real extraction capacitance after routing according to the method of the present invention.

### DETAILED DESCRIPTION OF THE INVENTION

IC design comprises stages of logic synthesis, floor plan, placement, clock tree synthesis, and routing, and then a target chip is fabricated. The present invention provides a method to forecast the unit capacitance of each layer of the target chip according to the layout design parameters of the target chip. Thus, the forecasted unit capacitance is applied to the design stages of floor plan, placement, and clock tree synthesis. Therefore, the unit capacitance of the fabricated chip will be close to the forecasted value.

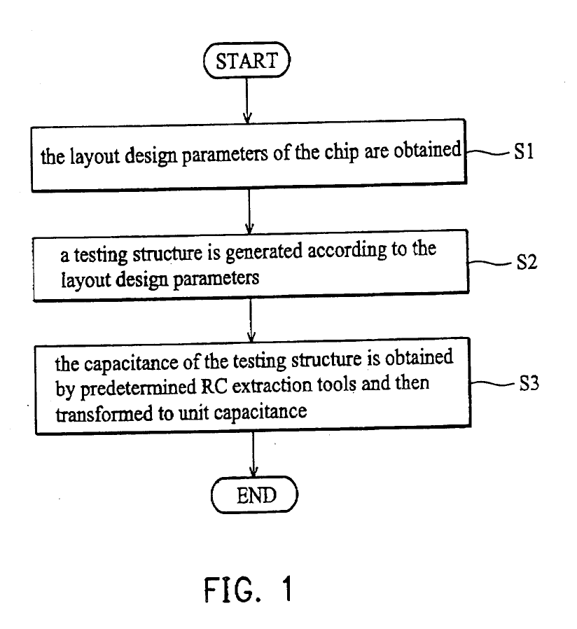

The method according to the present invention is described below. FIG. 1 shows a flowchart of the capacitance forecasting method according to the embodiment of the present invention.

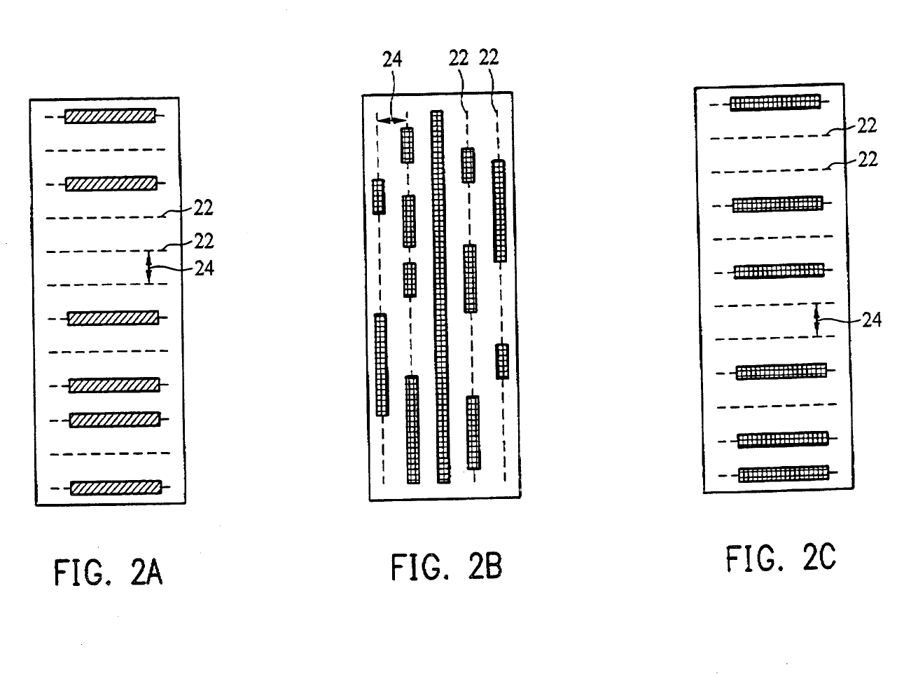

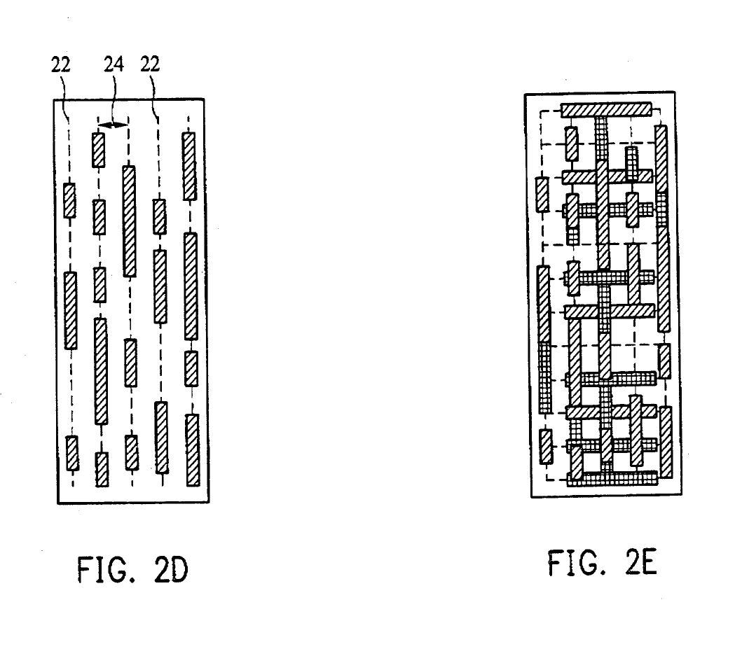

First, before forming the chip, the layout design parameters of the chip are obtained (S1), including number of layout layers, metal line width of each layout layer, distance between each metal line and the ratio of metal lines to routing channels. The routing channels constitute the permitted layout area of each layer. Next, a testing structure is generated according to the layout design parameters (S2). In the present invention, the testing structure is randomly generated by program lpeTestPatGen. FIGS. 2A-2E show the layout of metal lines of different layers of a chip, wherein FIG. 2A shows the MET1 layout, FIG. 2B shows the MET2 layout, FIG. 2C shows the MET3 layout, FIG. 2D shows the MET4 layout of a chip, and FIG. 2E shows a final metal line layout of the chip comprising MET1, MET2, MET3 and MET4 layouts.

Here, with an interconnection comprising four layers as an example, metal line layouts are sequentially shown in FIGS. 2A-2D. Generally, the metal lines of odd layers are routed horizontally (FIGS. 2A and 2C), and the metal lines of even layers are routed vertically (FIGS. 2B and 2D). In addition, the metal layers are all placed along routing grids (labeled 22) in horizontal or vertical directions, and the distance between the adjacent routing grids is labeled 24. Thus, the generated testing structure is arranged by setting the layout design parameters as mentioned above.

An example of the programming code for generating the simulating testing structure is described below. Here, the programming code is applied for determining the unit capacitance of MET1 and MET2.

#LAYER DEFINITION

#layerName=layerNo routing_grid

*LAYER

MET1=8 0.8

MET2=10 0.86

MET3=13 0.8

MET4=15 0.86

*ENDLAYER

{// MET1

MODEL=ROUTING_LINE

TOP_LAYER=MET4 ROUTING WIDTH=0.40 HORI UTILIZATION=50

TOP_LAYER=MET3 ROUTING WIDTH=0.42 VERT UTILIZATION=50

TOP_LAYER=MET2 ROUTING WIDTH=0.40 HORI UTILIZATION=50

MID_LAYER=MET1 WIDTH=0.32 PITCH1UTIL=50 PITCH2UTIL=50

}

{// MET2

MODEL=ROUTING_LINE

TOP_LAYER=MET4 ROUTING WIDTH=0.40 VERT UTILIZATION=50

TOP_LAYER=MET3 ROUTING WIDTH=0.42 HORI UTILIZATION=50

MIDLAYER=MET2 WIDTH=0.40 PITCH1UTIL=50 PITCH2_UTIL=50

BOT_LAYER=MET1 ROUTING WIDTH=0.32 HORI UTILIZATION=50

}

Thus, the testing structure is generated by program. In addition, the layout for determining the unit capacitance of MET2 of each layers are shown in FIGS. 2A-2D, and the result is a top view of the testing structure as shown in FIG. 2E.

Next, the capacitance of the testing structure is obtained by predetermined RC extraction tools and then transformed to unit capacitance (S3). Here, the predetermined RC extraction tools can be Raphael, Star-RC, Xcalibre, or DRACULA.

Unit capacitance is an important reference parameter for chip design, especially in the stages of floor plan and clock tree synthesis. If the unit capacitance of the chip is obtained, the designer can design the chip accordingly to adjust placement of electric elements. According to the experimental data, the unit capacitance of the fabricated chip will be close to the forecasted unit capacitance. Thus, IC design convergence is improved.

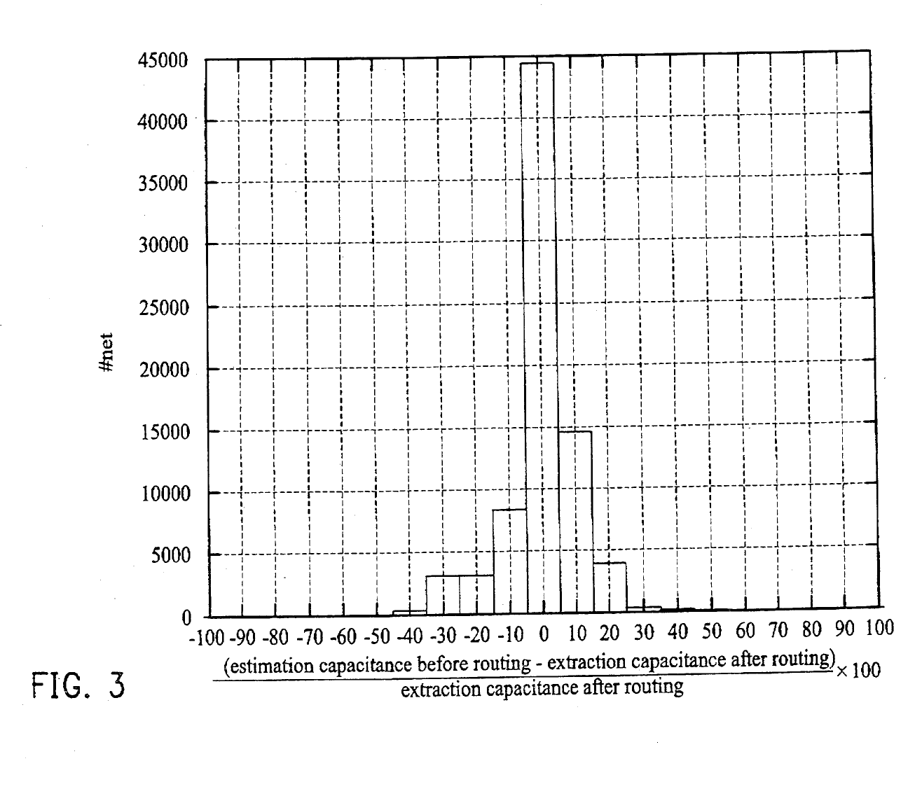

FIG. 3 shows the relationship between net count and the error ratio of the estimation capacitance before routing to real extraction capacitance after routing according to the method of the present invention. As shown in FIG. 3, the estimation capacitance obtained by the method of the present invention is close to the real extraction capacitance, with the error almost within 10%, an allowable range. In addition, the error ratio of the estimation capacitance to real extraction capacitance is inversely proportional to net count. Thus, the estimation method of the present invention is accurate when the circuit network is complicated.

Accordingly, the present invention provides a method of forecasting the unit capacitance of a predetermined interconnection layout by simulating a testing structure, and obtaining the unit capacitance of the testing structure by resistance-capacitance extraction tools. Then, the unit capacitance is applied to the IC design processes comprising logic synthesis, floor plan, and clock tree synthesis. Thus, the capacitance of the fabricated chip approaches the forecasted capacitance, so the IC design convergence is improved.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of forecasting a unit capacitance of a chip having a plurality of layers, each of which includes a predetermined layout of metal lines, comprising the following steps:
obtaining layout design parameters of the predetermined layout before forming the chip, wherein the layout design parameters are number of layout layers, metal line width of each layout layer, distance between each metal line and the ratio of metal lines to routing channels;
generating a testing interconnection according to the layout design parameters; and
obtaining the unit capacitance by a predetermined capacitance extraction tool according to the testing interconnection.

2. The method of forecasting a unit capacitance as claimed in claim 1, wherein the testing interconnection is randomly generated by predetermined program.

3. The method of forecasting a unit capacitance as claimed in claim 1, wherein the testing interconnection is similar to the layout of the chip.

4. The method of forecasting a unit capacitance as claimed in claim 2, wherein the predetermined program is lpeTestPatGen.

5. The method of forecasting a unit capacitance as claimed in claim 1, wherein the predetermined capacitance extraction tool is Raphael, Star-RC, Xcalibre, or DRACULA.

6. The method of forecasting a unit capacitance as claimed in claim 1, wherein the routing channels constitute the permitted layout area of each layer.
